(19) United States
(12) Patent Application Publication
(10) Pub. No.: US 2007/0167145 A1
(43) Pub. Date: Jul. 19, 2007

(54) Method for providing a system with position information from a mobile unit

(75) Inventor: Bjorn de Bonnenfant, Linkoping (SE)

Correspondence Address: THE WEBB LAW FIRM, P.C., 700 KOPPERS BUILDING, 436 SEVENTH AVENUE, PITTSBURGH, PA, 15219, US

(73) Assignee: FLEX TOLL AB, Linkoping (SE)

(21) Appl. No.: 10/555,724

(22) PCT Filed: May 7, 2004
(86) PCT No.: PCT/SE04/00688

§ 371 Date: Jul. 6, 2006

(30) Foreign Application Priority Data
May 7, 2003 (SE) 0301324-0

(51) Int. Cl. H04M 11/04

(52) U.S. Cl. 455/404.1; 455/414.4

(57) ABSTRACT

The invention relates to a method for providing a system that is operated by a first party, with position information from a mobile unit provided with a unique identity that belongs to a second party. The first party provides a service that is dependent of the position of the mobile unit, and the second party activates the use of the service. The method comprises the steps to send a signal from the mobile unit via a communication network, when the second party activates the use of the service, to a toll number associated with a certain charge, the signal comprises information regarding the identity of the mobile unit and position indication provided by the communication network, and to debit said charge from an account connected to the mobile unit and said second party. The invention also relates to a mobile unit and a system.

### TECHNICAL FIELD

The present invention relates to a technical field according to the method as defined in the preamble of claim 1. The invention also relates to a mobile unit as defined in the preamble of claim 16 and a system as defined in the preamble of claim 21.

### BACKGROUND TO THE INVENTION

In present systems for managing road tolls, there is a large initial cost regarding the building of infra structure, e.g. roads, toll stations, charging systems, and costs for operating the system with employed personnel. These costs must thereafter be paid by those who will use the area within the toll station for driving, and thus an increase in investment and maintenance costs. An example of a method for managing debiting in such a toll system is described in the published international patent application WO 99/31629.

In the alarm and protective transport systems that are currently used today, there is in most cases a dependency of positioning via GPS, which in it self is a very accurate technique, but unfortunately has some built-in weaknesses such as that at least three GPS satellites must be visible from the mobile unit for it to be able to calculate its position. A mobile unit is normally kept in a pocket, within a container, on a covered van, etc. and there is then impossible for the unit to update its position.

The telephone network may be used to find the position of a mobile telephone within a certain geographical region. Such a method is described in the published international patent application WO 00/59254, where mobile base stations are used to calculate the position of possible mobile telephones in an avalanche area. By weighting the received signals, using their different signal strength, between the base stations it is possible to determine the position of the mobile telephone, and thereby the person that may be buried in the avalanche.

### SUMMARY OF THE INVENTION

The object if the present invention is to provide a method and a mobile unit to supply a system with positioning information from the mobile unit to use this information to locate the mobile unit without the disadvantages mentioned above.

This object is achieved by the method as defined in the characterizing part of claim 1, and the mobile unit as defined in the characterizing part of claim 16, which is based on using an already built telephone network that in turn is based on a division of a geographic location, e.g. a city, into a plurality of cells, where the poisoning information from the mobile unit may be determined from the cells that receive signals from the mobile unit.

It is also an object to provide a system for tracking a mobile unit without the disadvantages mentioned above.

This object is achieved by the system as defined in the characterizing part of claim 21.

An advantage with the present invention is that it is simple to build up a toll system without heavy infrastructural costs.

Another advantage is that the present invention is simple to use compared to prior art techniques, for instance it is possible to follow transports of goods since the mobile unit regularly sends out its positioning information to a receiver.

A further advantage is that it is possible to connect sensors, and even alarm buttons, to the mobile unit to thereby be able to use the unit as a personal alarm, be able to detect unwanted movement of a car, boat, marine engine, etc.

A further advantage with the invention is that a reliable system is obtained, where included parts are not expensive to manufacture.

Further advantages and objects with the present invention will be apparent for skilled person in the arts from the following detailed description.

### BRIEF DESCRIPTION OF THE DRAWINGS

The different embodiments shown in the appended drawings are schematic and should only be seen as illustrations to clarify the invention, and should not be interpreted as limitations of the invention.

FIG. 1 shows a system for managing debiting of toll charges according to the invention.

FIG. 2 shows an overview of a toll area with adherent cells.

FIG. 3 shows a personal alarm system according to the invention.

FIG. 4 shows an anti-theft system according to the invention.

### DETAILED DESCRIPTION OF PREFERRED EMBODIMENTS

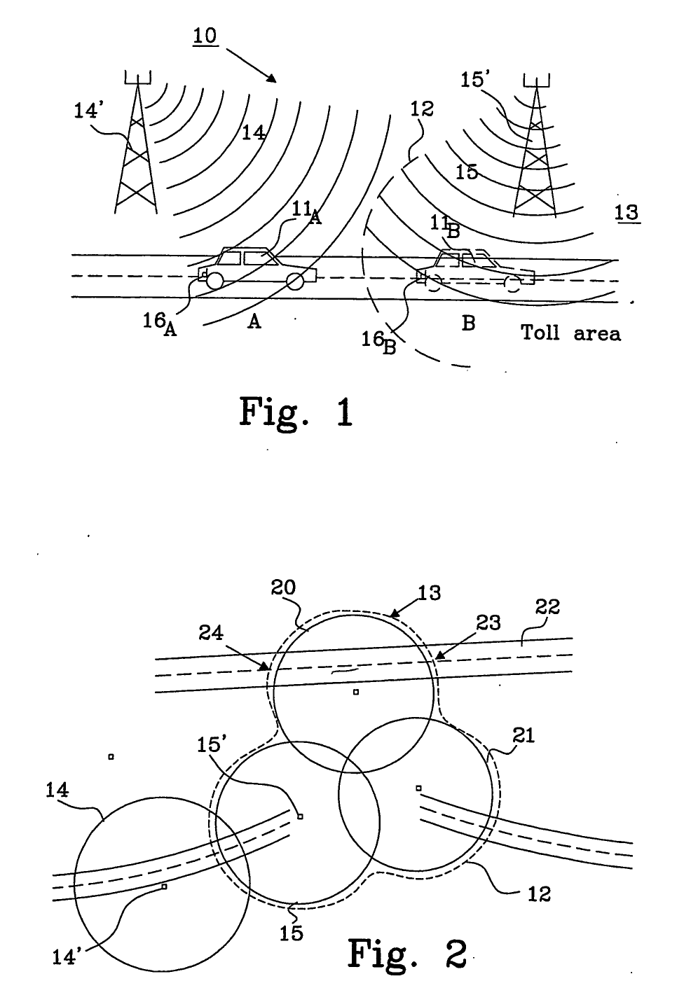

FIG. 1 shows a schematic view of a toll system 10, where a vehicle 11 is shown in a position A, denoted 11_{A}, outside a border 12 for the area that demand payment of a toll charge to be allowed to enter. The same vehicle 11 is also depicted in a position B within the toll zone 13, where the vehicle is shown with dashed lines and denoted 11_{B}.

Two base station antennas for a mobile telephone network, e.g. GSM 900, GSM 1800, PCS 1900, etc. are also shown in FIG. 1, where a first base station antenna that defines a first cell 14 is placed outside the toll zone 13, and a second base station antenna that defines a second cell 15 is placed inside the toll zone 13. A mobile unit 16, denoted 16_{A} and 16_{B}, is mounted in the vehicle 11.

The mobile unit may in its simplest embodiment consist of a mobile telephone, where a SIM card is mounted connected to a telephone subscription that belong to the person that should pay the toll charge, which in most cases is the owner to the vehicle. The mobile unit 16 is furthermore fixed mounted to the vehicle to make it simpler to use to register the number of occasions the vehicle passes into a toll zone 13, and how the vehicle 11_{B} moves within the toll zone.

In a more advances embodiment of the mobile unit 16, the key-pad and the display has been removed. Furthermore, energy saving algorithms has been implemented to increase the operational time for the internally arranged battery, such algorithms makes the unit decrease to a very low power consumption level for periods of time and regularly return back to normal function to check which cell in the mobile network the unit has contact with. In the application for tolls, the unit is always connected to a supply voltage, since the unit always should be used together with the vehicle. If the supply voltage is disconnected by any reason from the unit 16, its internal battery may continue to work up to several months. The processor and memory capacity on the SIM card, which preferably is mounted in the unit 16, are also used to manage the simple steps that are required to register toll charges according to the present invention.

To further clarify how the cells in a mobile network are used to build up a toll zone, a such zone 13 is shown in FIG. 2 comprising three cells 14, 20 and 21. The dashed line 12 constitutes the boundary for the zone 13 and follows the contour of the lobes of the base stations. The mobile unit should regularly be updated by a list of which cells that together constitutes the toll zone. This update may easily be performed by sending a SMS message to all mobile units 16 with a current list. The SMS message is thereafter unpacked automatically and installed in a suitable memory space (internally on the SIM card or in a separate memory in the unit 16). The formulation of the SMS message that is sent is easiest performed on an ordinary personal computer.

When a vehicle 11_{A} is situates outside the toll zone 13, the mobile unit 16_{A} has contact with the base station antenna 14′ in the cell 14 and when the boundary 12 is passed by the vehicle 11B, the base station antenna 15′ in cell 15 has also contact with the unit 16_{B}, which initiates a call to a toll number that debits the holder of the mobile subscription a predetermined amount, e.g. 20 Swedish kronor, since the cell 15 is on the list that defines the toll zone 13.

Other types of call may naturally be considered, e.g. SMS, MMS, etc. to register a debit entry of the toll charge.

This is the classical type of toll charge, but there are a number of variants that easily may be implemented with the help of the present invention.

Time based debiting: this debit entry depends on the time that the vehicle is present within a toll zone, where the toll zone even could be divided into zones where each has a predetermined time cost. For example, a scenario that is plausible is where it is a desired to reduce and divert traffic away from a certain area, e.g. old town in Stockholm. Therefore, the time based cost for the zone “Old town” is set to an amount that is twice the amount of neighboring zones “södermalm”, “city”, “östermalm”. This time based debiting is implemented by the mobile unit regularly calls a toll number that corresponds to the cost that is appropriate for the zone that the vehicle presently is in.

In this way it is easy to charge those that only drive within a toll zone 13 and then usually would not pass a boundary 12 and therefore should avoid debiting for entering a toll zone 13 as described above.

If a vehicle passes through a toll zone 13 on a through route 22, the charge that is debited when entering of the toll zone 23 may be compensated by fully or partially credit the holder of the mobile telephone subscription when leaving 24 the zone 13. A condition for such a crediting may be that the transport on the through route is performed within a certain time. In the usual case, the through routes are surrounded by its own cells, since many users of mobile telephones daily use these through routes, and this problem does not occur at all as these cells naturally is not part of the list of cells that belong to the toll zone.

If there is a problem with defining cells that only are used for through routes, it is possible to arrange special transmitters at suitable locations to exclude the system from generating a debit entry when the mobile unit is present within a toll zone but only passing on the through route.

It is naturally possible to debit a vehicle when it is leaving a toll zone, but this is not the usual way. The debiting principal is although the same as for entering the zone 13 except that the unit 16 initiates a call only when it detects cells that cannot be found in the list of cells that are a part of the toll zone.

The advantage with this system is that the toll company directly receives payment of those who are using roads within the zone 13.

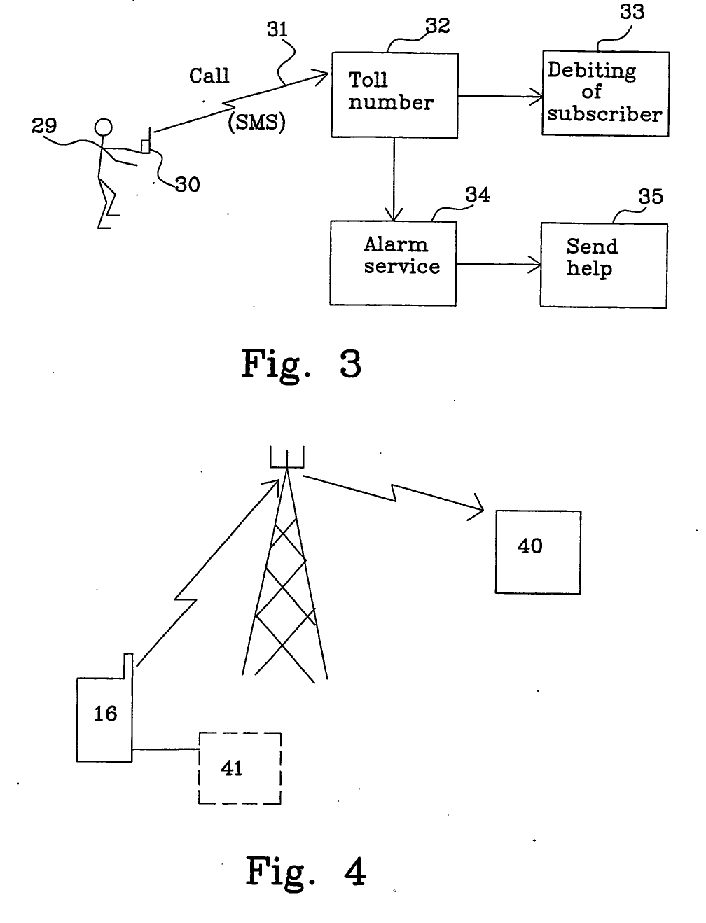

Another application of the present invention is shown in connection with FIG. 3, where a method for localizing a mobile unit in case of an alarm of any kind. Different types of alarm situations will be described in more detail below.

A mobile unit 16, that either may be placed together with goods that should be transported from one place to another or may be carried by a person, is provided with a means that is activated to send out a signal to a predetermined receiver under certain preconditions.

FIG. 3 shows the example when a person 29 carries a mobile unit 16 and where the unit 16 is provided with an alarm button 30. An alarm is activated when the alarm button is pushed; alternatively it is possible that an alarm is activated if the alarm button is not pushed at predetermined intervals.

When the alarm is activated a telephone call 31 is established, alternatively a SMS message is sent, to a toll number 32, whereby the person is charged directly on his/hers phone bill 33 which is attached to the subscription (SIM card) that is placed in the mobile unit 16, for using the alarm service. The message that is sent via the telephone call, or SMS, is forwarded to an alarm service 34 and contains information regarding who the person 29 is, so called identification, and an approximate position indication which is obtained by the mobile telephone network (e.g. GSM), i.e. indicate the cell within which the person is present. The accuracy for such a position indication is about 150-300 meters, which is enough to be able to fast locate the person in question and send help 35. The owner to the toll number 32 and the alarm service 34 could of course be the same party.

In the case when a telephone call is established, the carrier of the mobile unit has preferably already prerecorded a voice message that identifies the carrier, where the voice message is used for identification. The position indication is forwarded preferably as a link to a home page, where the position of the person can be seen. All this information can alternatively be sent in text form via a SMS as described above.

FIG. 4 shows how a system can be constructed and function to follow the position of an article during transport, but may also be used when tracking stolen boats, marine engines, rental cars, stolen cars, etc.

In the simplest case there is a functionality programmed into the mobile unit 16 that automatically, at regular intervals, activates it self and sends a message, preferably in the form of a text message (SMS, MMS) to a receiver 40, with information about the identity of the unit and the position of the unit, which is obtained by knowing which cell in a mobile telephone network the unit is present within.

By this method it is possible to detect unexpected movements of e.g. transport goods.

If it is not desired that the unit automatically should be sending updating information regarding its position, where every updating probably will be debited to the holder of the subscription for the SIM card that is in the unit 16, a SMS could be sent to the unit 16 when needed to activate a tracking of the same. This is especially interesting in case of a theft of e.g. marine engines (the unit could be mounted to an essential part of the engine), boats, cars, different types of valuables, etc. When it comes to marine engines, a such simple measure, as to provide the marine engine with a mobile unit during winter storage on land, could increase the chances of recovering a stolen marine engine essentially.

For rental cars there is a need to control that the vehicle is not used in a not appropriate way, e.g. transported outside the borders of the country to be sold in another less scrupulous country. By programming the unit 16 with information regarding a number of not allowed cells just outside the countries borders, and furthermore implement functionality that makes the unit regularly sense its position and compare it with the not-allowed cells, a message may be sent to the rental car company only when the car enters such a cell.

In addition to the functionality that may be built into the mobile unit, it may be complemented with various external sensors 41, e.g. motion sensors, audio sensors, that activates the unit by unexpected movements, sounds etc.

A preferred embodiment for managing debiting of alarm/anti-theft services is performed by sending the alarm/position updates via a SMS to a toll number, whereby the appropriate subscribed is debited. Correct information is thereafter forwarded to suitable receiver 34, 40 dependent on the service that respective mobile unit 16 is connected to.

The fundamental principal that makes the described invention function is that each cell in a cellular network has its unique identity. This identity is broadcasted from the antenna within each cell at regular intervals. This principal is well known to a person skilled in the arts, and therefore not explained in more detail.

The list of cells that is used in the present invention actually contains the broadcasted identity of the cells.

1-21. (canceled)

22. A method for providing a system that is operated by a first party, with position information from a mobile unit provided with a unique identity and belonging to a second party, the first party providing a service that is dependent of the position of the mobile unit, the second party activating the use of the service, the method comprising the steps of:
sending a signal from the mobile unit via a cellular communication network, when the second party activates the use of the service, to a toll number associated with a certain charge, the signal comprising information regarding the identity of the mobile unit and position indication provided by the cellular communication network depending on which cell the mobile unit is present in, each cell within the cellular communication network defining a geographic area; and
debiting said charge from an account connected to the mobile unit and said second party.

23. The method according to claim 22, wherein the communication network is a GSM network.

24. The method according to claim 22, wherein the signal that is sent from the mobile unit is sent in the form of a SMS.

25. The method according to claim 22, wherein said service is connected to a toll system, the mobile unit is provided with a list of which cells in the cellular communication network are a part of a toll zone, said service activated and a debit entry of a toll charge performed when the mobile unit moves into one of said cells from a cell that is not on the list, moves within at least one cell on the list, or any combination thereof.

26. The method according to claim 25, wherein when only a single charge is debited when the mobile unit moves into the toll zone, the second party is credited the single charge fully or partially if the mobile unit leaves the toll zone within a predetermined time period.

27. The method according to claim 25, wherein a time based charge is debited to the second party dependent on how long the mobile unit has been present within at least one cell on the list.

28. The method according to claim 27, wherein the toll zone is divided into sub zones, each of which has a pre-defined entering charge, a time based charge, or any combination thereof.

29. The method according to claim 25, wherein the list of cells that is a part of the toll zone is updated by generating a SMS that is sent to the mobile unit.

30. The method according to claim 25, wherein roads within the toll zone are excluded from generating a debit entry when the mobile unit is present thereby arranging special transmitters at suitable locations.

31. The method according to claim 22, wherein information in the signal, which is sent when the second party activates the service, is forwarded to a party that provides the service.

32. The method according to claim 31, wherein the service that is provided is a personal alarm service.

33. The method according to claim 31, wherein the service provided is a tracking service to track goods being transported, the service activated through automatic updates of the present position of the mobile unit.

34. The method according to claim 33, wherein the mobile unit is activated at regular intervals.

35. The method according to claim 33, wherein the service for the mobile unit may be initiated by sending a message to the unit.

36. The method according to claim 33, wherein the mobile unit is further provided with at least one external sensor, which activates an alarm/update at unexpected or undesired activities detected by the sensors.

37. A mobile unit for providing a system, operated by a first party, with position information, said mobile unit provided with a unique identity of a second party, the first party providing a service that is dependent of the position of the mobile unit, the second party activating the use of the service, the mobile unit comprising:
means for sending a signal via a cellular communication network, when the second party activates the use of the service, to a toll number associated with a certain charge, the signal comprising information regarding the identity of the mobile unit and position indication provided by the cellular communication network depending on which cell the mobile unit is present in, each cell within the cellular communication network defining a geographic area.

38. The mobile unit according to claim 37, wherein the mobile unit is used in a toll system and includes a list of which cells in the cellular communication network that are part of a toll zone.

39. The mobile unit according to claim 38, wherein the mobile unit is provided with means to receive an updated list of cells.

40. The mobile unit according to claim 37, wherein the mobile unit is used as a personal alarm, and includes an alarm button that activates the service.

41. The mobile unit according to claim 37, wherein the mobile unit is used for tracking goods and includes means for sending automatic updates of the present position of the mobile unit.
